(19) United States
(12) Patent Application Publication
(10) Pub. No.: US 2017/0336431 A1
(43) Pub. Date: Nov. 23, 2017

(54) SYSTEM AND METHOD FOR MEASURING EXHAUST FLOW VELOCITY OF SUPERSONIC NOZZLES

(71) Applicant: Purdue Research Foundation, West Lafayette, IN (US)

(72) Inventors: Jared D. Willits, Lafayette, IN (US); Timothee L. Pourpoint, West Lafayette, IN (US)

(73) Assignee: Purdue Research Foundation, West Lafayette, IN (US)

(21) Appl. No.: 15/600,700

(22) Filed: May 19, 2017

Related U.S. Application Data
(60) Provisional application No. 62/338,567, filed on May 19, 2016.

(51) Int. Cl. G01P 5/26; G01P 5/00; G01S 17/58; G01S 17/50

(52) U.S. Cl. CPC G01P 5/26; G01S 17/58; G01P 5/001; G01S 17/50

(57) ABSTRACT

A system for measuring supersonic nozzle exhaust flow, comprising a seeding module, an optics module configured to direct an optical signal from the supersonic nozzle, and a streak camera. The streak camera is optically connected to the optical signal, the streak camera configured to image the path of the seed particles traveling in the nozzle exhaust flow. The seeding module includes a seed particle container and a seed particle injector configured to inject seed particles into a supersonic nozzle flow. The streak camera comprises a photocathode, a sweep module, a micro-channel plate, a phosphor screen, and a charged coupled imaging device.

### CROSS-REFERENCE TO RELATED APPLICATIONS

The present patent application is related to and claims the priority benefit of U.S. Provisional Patent Application Ser. No. 62/338,567, filed May 19, 2016, the contents of which is hereby incorporated by reference in its entirety into the present disclosure.

### TECHNICAL FIELD

The present application relates to supersonic propulsion systems, and more specifically, to a system and method for measuring exhaust flow velocity of supersonic nozzles.

### BACKGROUND

Several known methods exist to obtain a flow velocity measurement. Intrusive methods include hotwire anemometry, Pitot-static probes, and turbines among others. Due to material constraints, these are likely not viable for high temperature and corrosive flows characteristic of rocket nozzles. Non-intrusive (or minimally so) methods rely on optical techniques often involving high speed cameras and powerful lasers. Examples include: Schlieren imaging where gradients in refractive index can be visualized by passing a collimated beam through the flow, Doppler where the spectral shift from a stimulated flame emission or an illuminated particle is recorded, and visual particle tracking techniques such as Particle Image Velocimetry (PIV) where a seed material is added to the flow and illuminated.

A key distinction in the non-intrusive methods is the requirement of known flow composition. Shock waves observed by Schlieren can provide Mach number which requires molecular composition and temperature information to convert to velocity. Doppler methods using laser excitation techniques such as Raman spectroscopy are referenced to emission wavelengths of specific species in the exhaust. In contrast, seeded particle techniques require less stringent knowledge of flow properties making them more ideal for investigation of wholly new propellant formulations. Particles must simply be sized such that the velocity lag relative to length and time scales in the flow of interest is sufficiently small. Provided that background flame emissions can be filtered out from the seed signal, seeded techniques can be applied in the exact same manner irrespective of the exhaust plume composition.

While non-seeded techniques require more information than seeded techniques, some, such as Doppler, become more resolvable as velocity increases. Conversely, velocities of seeded flows have an upper limit based on the system. In PIV, the maximum velocity is governed by the window length and the time step between frames. A conventional metric for PIV to avoid aliasing is that the particle displacement across one frame pair must be at least four times smaller than the interrogation windows. Pulsed illumination sources can easily reach down to sub-nanosecond separation time, but the shutter speed of commercially available, cutting-edge cameras used to image such flows is typically limited to between 100 and 500 ns. The measured velocity is averaged across an entire window meaning that constant or linearly accelerating flows produce accurate mean values at the window center location. However, this is not valid for flow fields with high velocities and non-linear acceleration in the direction of the flow; both of which are characteristic of rocket exhaust flows. At time scales of 100 to 500 ns, the interrogation window size required to accurately resolve the magnitude and position of velocity vectors without aliasing becomes prohibitively small. Therefore, improvements are needed in the field.

### SUMMARY

The present disclosure provides a system for measuring exhaust flow velocity of supersonic nozzles. The system comprises a seeding module, an optics module, and a streak camera. The seeding module injects seed particles into a nozzle flow. The streak camera comprises a photocathode, a sweep module, a micro-channel plate, a phosphor screen, and a charged coupled imaging device. On a single frame, a signal on the y-axis is swept across the x-axis at a controlled rate and the time step is governed by the dwell time on each pixel using the streak camera.

### BRIEF DESCRIPTION OF THE DRAWINGS

In the following description and drawings, identical reference numerals have been used, where possible, to designate identical features that are common to the drawings.

FIG. 1 is a diagram showing a cutaway view of a supersonic nozzle for testing exhaust flow according to various aspects.

FIG. 2 shows a seeding module for injecting seeded particles into a bulk exhaust flow according to various aspects.

FIG. 3 is a diagram showing an example measurement apparatus for directing an optical seed signal from seed particles to a streak camera according to various aspects.

FIG. 4 is a diagram showing a streak camera for capturing incident light reflected from the seed particles according to various aspects.

The attached drawings are for purposes of illustration and are not necessarily to scale.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

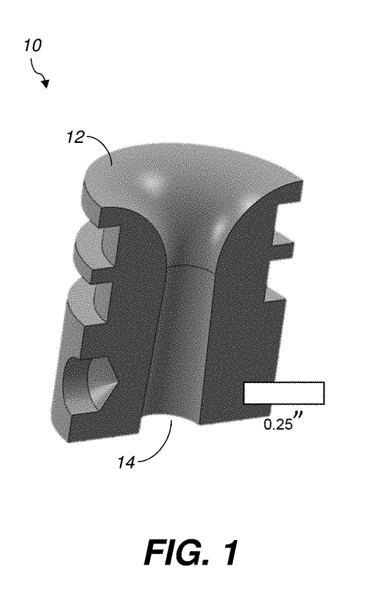

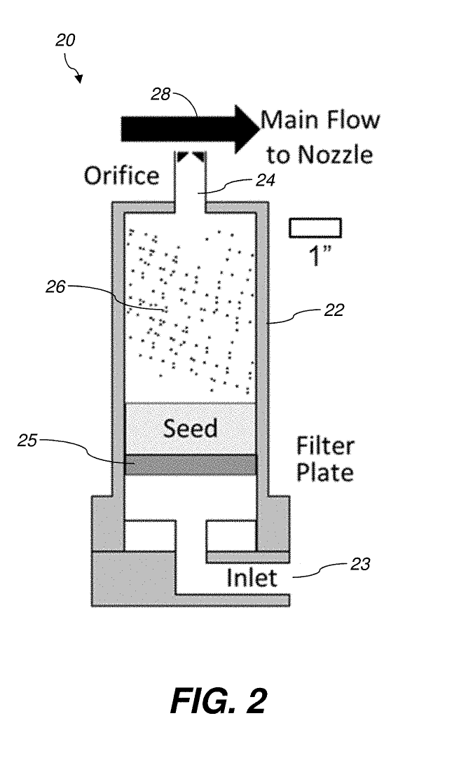

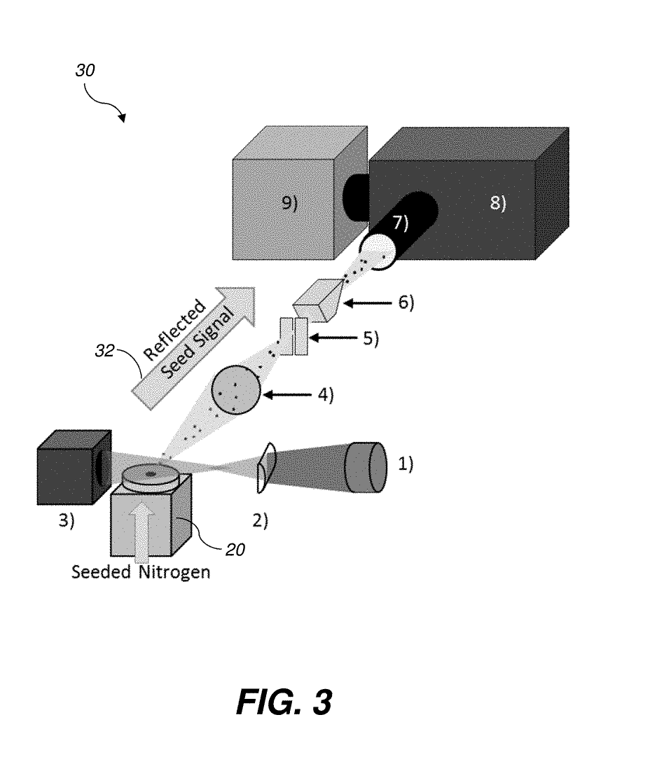

FIG. 1 shows cutaway view of a supersonic nozzle 10 for testing an exhaust flow. The exhaust flow enters the top portion 12 of the nozzle and exits out the bottom portion 14. FIG. 2 show a seeding module 20 which has a seed particle container 22, inlet 23, filter plate 25 and an injector 24 for injecting seed particles 26 into the bulk exhaust flow 28. The velocity of the seed particles 26 is measured by directing reflected light from the seed particles 26 to a streak camera 9. FIG. 3 shows an example measurement apparatus 30 for directing an optical seed signal 32 from the particles 26 to the streak camera 28. The seed particles 26 may comprise, but are not limited to, TiO₂, SiC, or other materials.

The measurement apparatus 30 includes a laser light source 1 (e.g., a laser diode), a focusing lens 2, a beam dump 3, a positive spherical lens 4, a micrometer slit 5, a prism 6, a macro lens 7, a spectrometer 8, and the streak camera 9. The laser light source 1 is oriented with the linearly polarized axis vertically oriented. The output of the laser light source 1 is formed into an expanding sheet using a collimating lens and the cylindrical lens 2. The horizontal waist is located at the nozzle center line with the sheet height being approximately 5 mm in one example and positioned at the nozzle exit plane. The spherical lens 4 and micrometer slit 5 act as a field stop to limit the width of the axial line being imaged. This allows further control of the number of particles being imaged and the total light intensity. The dovetail prism rotates the image 90° to align with the streak camera 9 photocathode orientation. A 200 mm f/4 macro Nikon lens is used in one example to collect the image. In one example, the spectrometer is a UV-Vis spectrometer, but for the purposes of this experiment, this is bypassed by setting the diffraction grating to a zero-order reflection which will act as a plane mirror directing the signal into the streak camera 9.

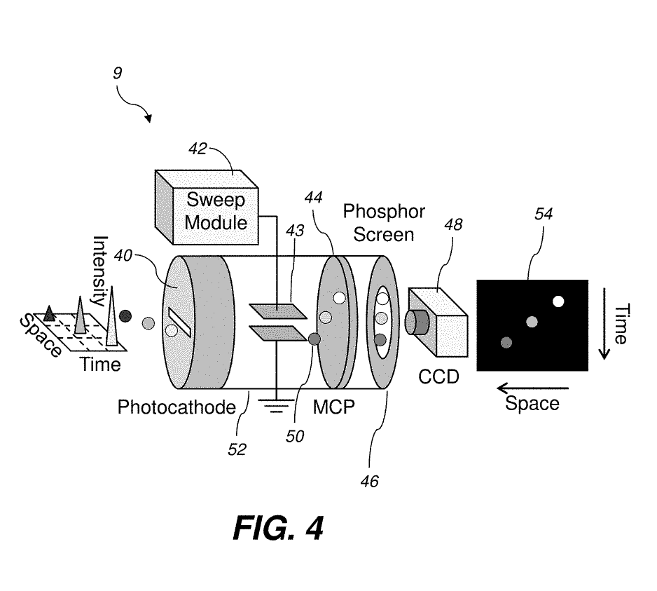

The streak camera comprises a photocathode 40, a sweep module 42, a micro-channel plate 44, a phosphor screen 46, and a charged coupled imaging device (CCD) 48 as shown in FIG. 4. The streak camera 9 records images by directing the incident light reflected from the seed particles 26 onto the photocathode 40 which outputs electrons 50. These electrons 50 are diverted by the sweep module 42 via a changing electric field between plates 43 inside a streak tube 52. The rate at which the field changes governs the temporal axis of the resulting data. The micro-channel plate 44 multiplies these electrons 50 which are then converted back to photons by the phosphor screen 46. The image 54 is then captured by the CCD 48 with one axis indicating space and the other time. By measuring the angle of the streaks in the image 54, the velocity can be determined. Because the electric field can be swept across each pixel much more quickly than a traditional high speed shutter can cycle, extremely fine temporal resolutions can be achieved at the cost of one spatial axis. One suitable example streak camera is the Sydor Instruments Ross 2000 which provides recording times from 30 ms to 300 ns with 25 μs to 236 ps resolution, respectively.

The elimination of the shutter allows the system 30 to operate with a continuous light source as opposed to the frame straddling of dual pulse lasers used in prior art systems. An example system of the type described herein uses a 1.6 Watt, 445 nm laser diode with a 2 Amp switching DC power supply. The micro channel plate 44 integrated into the streak camera 9 provides a lower detection threshold than CCD or CMOS detectors alone.

The invention is inclusive of combinations of the aspects described herein. References to “a particular aspect” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A system for measuring supersonic nozzle exhaust flow, comprising:
a seeding module, the seeding module having a seed particle container and a seed particle injector configured to inject seed particles into a supersonic nozzle flow;
an optics module configured to direct an optical signal from the supersonic nozzle; and
a streak camera optically connected to the optical signal, the streak camera configured to image the path of the seed particles traveling in the nozzle exhaust flow.

2. The system of claim 1, wherein the seed particles comprise TiO₂.

3. The system of claim 1, wherein the seed particles comprise SiC.

4. The system of claim 1, wherein the nozzle is a supersonic rocket nozzle.

5. The system of claim 1, wherein the streak camera comprises a photocathode, a streak tube, a sweep module which adjust an electric field inside the streak tube to change the direction of electrons being output from the photocathode, a micro-channel plate which multiplies the electrons, a phosphor screen which receives the electrons and converts them to photons, and a charged coupled imaging device which senses the photons to form an image.

6. A method for measuring supersonic nozzle exhaust flow, comprising:
injecting seeded particles into a supersonic exhaust flow using a seeding module, the seeding module having a seed particle container and a seed particle injector configured to inject seed particles into the supersonic nozzle flow;
directing an optical signal from the flow via an optics module to a streak camera optically connected to the optical signal, the streak camera configured to image the path of the seed particles traveling in the nozzle exhaust flow.

7. The method of claim 6, wherein the seed particles comprise TiO₂.

8. The method of claim 6, wherein the seed particles comprise SiC.

9. The method of claim 6, wherein the nozzle is a supersonic rocket nozzle.

10. The method of claim 6, wherein the streak camera comprises a photocathode, a streak tube, a sweep module which adjust an electric field inside the streak tube to change the direction of electrons being output from the photocathode, a micro-channel plate which multiplies the electrons, a phosphor screen which receives the electrons and converts them to photons, and a charged coupled imaging device which senses the photons to form an image.
